(19) United States
(12) Patent Application Publication
(10) Pub. No.: US 2024/0146073 A1
(43) Pub. Date: May 2, 2024

(54) SERIAL TAPPED INDUCTOR BATTERY BALANCER

(71) Applicant: Smartville, Inc., Carlsbad, CA (US)

(72) Inventor: William von Novak, San Diego, CA (US)

(21) Appl. No.: 18/496,651

(22) Filed: Oct. 27, 2023

Related U.S. Application Data
(60) Provisional application No. 63/381,161, filed on Oct. 27, 2022.

(51) Int. Cl. H02J 7/00

(52) U.S. Cl. CPC H02J 7/0019; H02J 7/0048; H02J 7/00712

(57) ABSTRACT

A battery balancing device may comprise: a positive terminal of a power source connected to a first cell and an alpha switch; a second cell and a first switch both in connection with a negative terminal of the first cell; and a third cell and a second switch both in electrical connection with the negative terminal of the second cell. The alpha switch may be in series with a first inductor, the first inductor may be both in electrical connection with the first switch and a second inductor, the second inductor may be both in electrical connection with the second switch and a third inductor; the third inductor may be in series with a beta switch; and the beta switch and the third cell may both be in electrical connection with a negative terminal of the power source. Moreover, a method for balancing a string of battery cells is provided.

### CROSS-REFERENCE TO RELATED APPLICATION

This application claims priority to, and the benefit of, U.S. Provisional Patent Application No. 63/381,161 filed on Oct. 27, 2023 entitled “Serial Tapped Inductor Battery Balancer”. The contents of the foregoing application are hereby incorporated by reference for all purposes (except for any subject matter disclaimers or disavowals, and except to the extent that the incorporated material is inconsistent with the express disclosure herein, in which case the language in this disclose controls).

### FIELD OF INVENTION

The present disclosure relates generally to battery balancing and, in particular, to balancing a series of battery cells or modules in energy storage systems.

### BACKGROUND

Systems, methods, and devices that improve the balancing of cells in a stack may be desirable. For example, it may be desirable to improve the efficiency, accuracy, and speed of balancing cells in a stack of cells for an energy storage system.

Batteries are used for storage of energy in applications from cellphones to Electric Vehicles (“EV”'s) to large grid scale storage systems. For small devices (cellphones for example) a single cell is often used. These are easy to charge and manage. Large systems often use more than one cell in series to provide higher voltages and energies. Some cell chemistries (like lead acid) have an inherent balancing mechanism; if a cell is overcharged it tolerates it and allows all the other cells to ‘catch up’ in charge state until all are at a similarly high state of charge.

Some chemistries, however, do not accommodate overcharge well. Lithium chemistry secondary batteries will be damaged due to overcharge, for example. Hence, when several lithium batteries are put in series, it is necessary to use some kind of balancing circuit to ensure that no one cell is overcharged (or over discharged, which can also damage cells.)

It should be noted that a BMS (battery management system) will often monitor cells and disconnect the pack when any cell sees too high or too low a voltage. However, this means that an “out of balance” pack, where one cell has an unusually high charge level or one cell has an unusually low charge level, will not provide its rated output, since the high cell will cause early disconnect during charging, and the low cell will cause an early disconnect during discharging. Thus a 100-amp hour battery might be limited to 50-amp hours, reducing the utility of the battery. To overcome this, battery balancing is often used. Balancing uses a variety of methods to get all cells to a similar state of charge, thus maximizing the capacity of the battery pack.

There are many ways to do balancing. A common one is resistive balancing, where a resistive load is placed across the terminals of the highest cell. This reduces its charge level until it is in line with the other cells. However, this is not very efficient for high energy batteries, since resistive loads waste energy and create a lot of heat. A non-dissipative, but simple and cheap, way to balance batteries would help make batteries more useful and cheaper to use.

The goal of balancing is to ensure that the battery can deliver the most possible energy without damage due to overcharge or undercharge. In various embodiments, the cells may be top balanced or bottom balanced.

The top balancing approach charges all cells as high as possible, then when one cell approaches 100% charge, its charge rate is decreased or discontinued until other cells approach 100%. This continues until all cells are at or close to 100% charge. In this manner, all cells are balanced when they are at the “top” of the charge cycle, but are uncontrolled during discharge. During discharge, the first cell that hits 0% charge terminates the discharge. It is expected that cells will not be balanced at the bottom of discharge, thus limiting energy.

The bottom balancing approach is similar to the strategy above, but done at the bottom of discharge. Thus, during discharge, as a cell approaches 0%, its discharge is slowed or stopped until all other cells “catch up.” Once all cells are at or close to 0% discharge is stopped. During charge, the first cell to hit 100% ends the charge. Again, this limits the amount of energy that the battery has stored.

Constant voltage balancing. Since cell voltage can be a proxy for cell charge state, some systems may be configured to cause the same voltage on all cells. Charge can be moved from high-voltage cells to low-voltage cells. Since this keeps all cells at approximately the same percentage of charge, this maximizes energy available from the battery.

Constant charge state balancing. This measures the actual charge state of each cell via a method like resting-voltage measurement or charge accumulation. All cells are then balanced to maintain a similar charge state. In the case of mismatched cells (one cell with a 10 ah capacity and one with a 9 ah capacity) the system maintains the same charge ratio rather than the same charge state. In other words, both cells are kept at the same percentage of their total charge rather than the same charge level in amp-hours.

Each of these strategies has certain disadvantages, and it is desirable to have an improved system for balancing batteries.

### SUMMARY

In an example embodiment, a serial tapped inductor battery balancing device is disclosed. The device may comprise: a positive terminal of a power source connected to a first cell and an alpha switch; a second cell and a first switch both in electrical connection with a negative terminal of the first cell; and a third cell and a second switch both in electrical connection with the negative terminal of the second cell. In this example embodiment, the alpha switch may be in series with a first inductor, the first inductor may be both in electrical connection with the first switch and a second inductor, the second inductor may be both in electrical connection with the second switch and a third inductor; the third inductor may be in series with a beta switch; and the beta switch and the third cell may both be in electrical connection with a negative terminal of the power source.

In an example embodiment, a system for serial tapped inductor battery balancing is disclosed. The system may comprise: a chain of cells and a chain of inductors; a power source connected to the chain of inductors and the chain of cells, wherein the chain of inductors is connected to a positive terminal of the power source by an alpha switch, and to a negative terminal of the power source by a beta switch; and a first switch connected between the chain of cells and the chain of inductors, wherein the first switch is connected to the chain of cells between a first cell and a second cell; and wherein the first switch is connected to the chain of inductors between a first inductor and a second inductor.

In an example embodiment, a serial tapped inductor battery balancer is disclosed. The balancer comprising: a string of cells in series; a power source connected by a positive terminal of the power source to a first end of the string of cells and by a negative terminal to a second end of the string of cells; and an alpha switch in series with a beta switch. In this example embodiment, the alpha switch is connected to the positive terminal of the power source; and the beta switch is connected to the negative terminal of the power source. In this example embodiment, a first switch is connected on a first end between a first cell and a second cell in the string of cells, the first switch is also connected on a second end between the alpha switch and the beta switch; and a controller is configured to control the first switch, the alpha switch and the beta switch to upbalance or downbalance one or more of the cells in the string of cells.

In another example embodiment, a method for balancing a string of battery cells comprises: providing, by a power source, current to a string of two or more cells; determining, by a controller, a state of charge of each of the two or more cells in the string of cells; and controlling the balance of the cells, by the controller, an alpha switch, a beta switch, and one or more internal switches based on the measuring of the state of charge of each of the two or more cells in the string of cells. In this embodiment, the number of internal switches is one less than the number of cells in the string of cells, and each of the one or more internal switches is connected on a first end between two cells of the string of cells and on a second end between the alpha switch and the beta switch.

### BRIEF DESCRIPTION OF THE DRAWING FIGURES

Additional aspects of the present disclosure will become evident upon reviewing the non-limiting embodiments described in the specification and the claims taken in conjunction with the accompanying figures, wherein like numerals designate like elements, and:

FIG. 1A is a circuit for battery balancing including three cells, in accordance with various embodiments;

FIG. 1B is a circuit for battery balancing including four cells, in accordance with various embodiments;

FIG. 1C is a circuit for battery balancing including two cells, in accordance with various embodiments;

FIG. 2 is a more detailed version of the circuit of FIG. 1C, in accordance with various embodiments;

FIG. 3 is a block diagram illustrating a system for battery balancing, in accordance with various embodiments;

FIG. 4 is a flow diagram illustrating an example method for balancing a string of battery cells; and

FIGS. 5A-5D are circuit diagrams illustrating various unbalancing and downbalancing strategies, in accordance with various embodiments.

### DETAILED DESCRIPTION

Reference will now be made to the example embodiments illustrated in the drawings, and specific language will be used herein to describe the same. It will nevertheless be understood that no limitation of the scope of the disclosure is thereby intended. Alterations and further modifications of the inventive features illustrated herein, and additional applications of the principles of the disclosure as illustrated herein, which would occur to one skilled in the relevant art and having possession of this disclosure, are to be considered within the scope of the disclosure.

In accordance with various embodiments, systems, devices and methods are provided for battery balancing. In some typical balancing systems, dissipative balancing may be used to balance cells of a battery. In dissipative balancing systems, energy is dissipated by using energy from “overcharged” cells. The simplest way to do this is with resistors that are placed across the overcharged cell, thus discharging it and dissipating that energy as heat. This is the most common method used for small, simple batteries like laptop or e-bike batteries. In most instances, dissipative balancing systems are used for top balancing.

In other typical balancing systems, capacitive charge transfer may be used to balance cells of a battery. Capacitive charge transfer uses a flying capacitor to equalize charge voltages. A capacitor is placed across a high voltage cell and allowed to charge. It is then moved to a low voltage cell and allowed to discharge. In this way charge is transferred from high voltage to low voltage cells. In various example embodiments, capacitive charge transfer is most commonly used for constant voltage balancing.

In yet other typical balancing systems, switchmode power transfer may be used to balance cells of a battery. In switchmode power transfer, any cell can have power transferred to or from it via a separate switchmode supply on each cell. Some systems allow only one direction (charge or discharge), and some systems allow both directions. This is generally used for constant charge state balancing.

In yet other typical balancing systems, direct per-cell charging may be used to balance cells of a battery. In direct per-cell charging, one charger per cell is utilized. Thus, direct per-cell charging may be thought of as a variation on top balancing. This is most often used for RC (remote control) batteries since the balancing is performed by an externally connected device, thus reducing battery weight. One issue with direct per cell charging is that larger/higher voltage batteries are more difficult to balance because direct per-cell charging requires one charger per cell.

In yet other typical balancing systems, flying-cell balancing may be used to balance cells of a battery. In flying-cell balancing, a separate cell is used to shuttle charge between cells. For example, in one particular eV battery (96 cells) a 97th cell is added, and that cell is used to move charge between cells. In such a system, the added cell would typically be connected to the highest voltage cell, then the lowest voltage cell, over and over again. As those two cells came back into balance the system would choose another two cells to represent highest and lowest cells and the process would repeat.

There is a need for more efficient battery balancing devices that are effective at balancing larger batteries.

In accordance with various example embodiments, a string of inductors may be used to balance a string of one or more cells. In various embodiments, the balancing may be performed on individual cells or subassemblies of cells. In various embodiments, the one or more cells may be connected to comprise a stack of cells. In various embodiments, the string of inductors may include one or more switches to perform non-dissipative balancing of a plurality of battery cells.

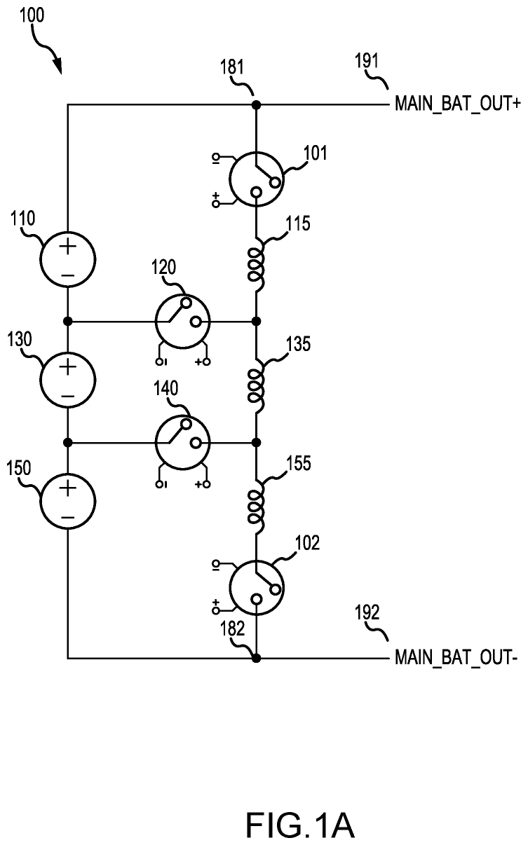

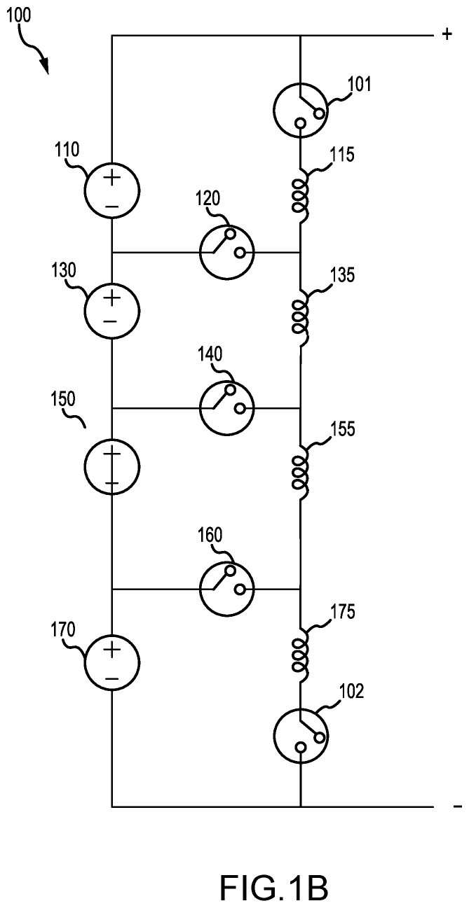

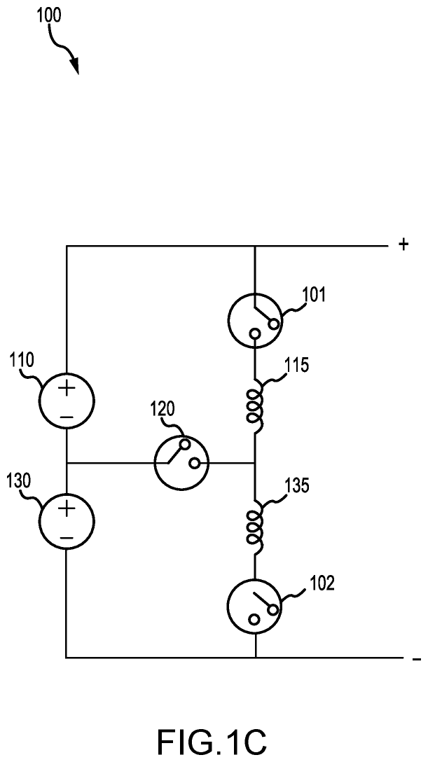

With reference to FIGS. 1A-1C, in various embodiments a balancer circuit 100 may be connected to a power source. In various embodiments, the balancer circuit 100 may comprise a string of one or more sub-batteries or cells. In various embodiments, the sub-batteries may be individual cells or collections of cells. The term cells may be used interchangeably to refer to the cells, individual cells, sub-batteries, and/or collections of cells.

In various embodiments, the power source may be used to provide current to the balancer circuit 100. In various embodiments, the power source may provide current to a string of two or more cells. In various embodiments, the power source may be connected to a first end 181 of the string of two or more cells at a positive terminal 191. In various embodiments, the positive terminal 191 of the power source may be connected to a first cell 110 and an alpha switch 101. In various embodiments, the power source may be connected to a second end 182 of the string of two or more cells at a negative terminal 192. In various embodiments, the negative terminal 192 of the power source may be connected to the third cell 150 and to a beta switch 102. In various embodiments, the power source may be connected to the Nth cell. In various embodiments, the power source may be connected to a chain of inductors and a chain of cells, wherein the chain of inductors is connected to the positive terminal 191 of the power source by the alpha switch 101, and to a negative terminal 192 of the power source by the beta switch 102.

In various embodiments, the balancer circuit 100 may comprise a string of cells. For example, in various embodiments, the balancer circuit 100 may include first cell 110, a second cell 130, a third cell 150, and a fourth cell 170. In various embodiments, the cells may be connected in series, creating a chain of cells or string of cells. For example, the positive terminal of the first cell 110 may be connected to the positive terminal 191 of the power source and the negative terminal of the third cell 150 may be connected to the negative terminal 192 of the power source. In various embodiments, there may be N cells in a string of cells, wherein each of the cells are connected in series.

In various embodiments, the positive terminal of the first cell 110 may be connected to the positive terminal 191 of the power source. In various embodiments, the negative terminal of the first cell 110 may be connected to the positive terminal of the second cell 130 and to a first switch 120 (also referred to herein as an internal switch). In various embodiments, the positive terminal of the second cell 130 may be connected to the negative terminal of the first cell 110 and the first switch 120. In various embodiments, the negative terminal of the second cell 130 may be connected to a second switch 140 (also referred to herein as an internal switch) and to the positive terminal of a third cell 150. In various embodiments, the positive terminal of the third cell 150 may be connected to the negative terminal of the second cell 130 and to the second switch 140. In various embodiments, the negative terminal of the third cell 150 may be connected to the negative terminal 192 of the power source.

In an example embodiment, the balancer circuit 100 may include a string of inductors. For example, in various embodiments, the balancer circuit 100 may include a first inductor 115, a second inductor 135. In other embodiments, the balancer circuit 100 additionally may include a third inductor 155, and potentially a fourth inductor 175. In various embodiments, the inductors may be connected to each other in series, creating a chain of inductors or string of inductors. In various embodiments there may be N inductors in the string of inductors. In various embodiments, the number of inductors may be equal to the number of cells in the string of cells. In various embodiments, the junction between each of the inductors may be connected to a corresponding internal switch. In various embodiments, the inductors are connected in series, and the series of inductors are connected on one end to the positive terminal of the power source and on a second end to the negative terminal of the power source. In various embodiments, a chain of inductors is connected to the positive terminal 191 of the power source by an alpha switch 101, and to a negative terminal 192 of the power source by a beta switch 102.

In various embodiments, the string (or chain) of inductors may be connected on a first end to the alpha switch 101 and on a second end to the beta switch 102. In various embodiments, the first inductor 115 may be in connection with an alpha switch 101 on a first end of the first inductor 115, and may be in connection with a first switch 120 and a second inductor 135 on a second end of the first inductor 115. In various embodiments, the second inductor 135, on its first end, may be in electrical connection with the first switch 120 and the second end of the first inductor 115. The second inductor 135 may furthermore, on its second end, may be in electrical connection with the second switch 140 and a first end of the third inductor 155. In various embodiments, the third inductor 155 may, on its first end, be in electrical connection with the second end of second inductor 135 and the second switch 140. And the third inductor 155 may furthermore be in electrical connection, on its second end, with the beta switch 102.

In an example embodiment, the balancer circuit 100 may comprise one or more internal switches. For example, in various embodiments, the internal switches may include a first switch 120. In other example embodiments, the internal switches may include a second switch 140, and possibly a third switch 160. In various embodiments, the number of internal switches may be equal to N−1, where N is the number of cells or the number of inductors. In various embodiments, the internal switches are connected between the string of cells and the string of inductors. For example, and as shown in FIGS. 1A-1C, an internal switch is connected between the connection of each of the cells and the connection of each of the inductors. The internal switches may be configured to allow current to flow bi-directionally. In various embodiments, the internal switches may be “slow” switches such as FETs, bipolar transistors, or mechanical relays. In various embodiments, the internal switches may open or closed at a rate less than or equal to once a second. In various embodiments, the internal switches may switch at a rate that is slower than the rate of switching of the alpha and beata switches.

In various embodiments, the one or more internal switches may be connected between a chain of cells and a chain of inductors. For example, a first switch 120 may be connected on a first end between a first cell 110 and a second cell 130, and on second end between a first inductor 115 and a second inductor 135. The first switch 120 may be connected to the alpha switch 101 by a first inductor 115. The first switch 120, may also be referred to as a first internal switch. In some example embodiments, an internal switch is a switch that is electrically connected between the alpha and beta switches. In some example embodiments, an internal switch is a switch that is not an alpha or beta switch.

In various embodiments, a second switch 140 may be connected on a first end between a second cell 130 and a third cell 150, and on second end between a second inductor 135 and a third inductor 155. The second switch may be connected to the beta switch 102 by a third inductor 155.

In an example embodiment, the balancer circuit 100 may comprise an alpha switch 101 and a beta switch 102. In various embodiments, the alpha switch 101 and the beta switch 102 may be fast switches, such as MOSFET switches. In various embodiments, the alpha switch 101 and the beta switch 102 are configured to close or reduce the current passing through the switch by rapidly opening and closing. For example, in various embodiments, the alpha switch 101 and the beta switch 102 may partially close or periodically close, meaning the switches rapidly open and close to reduce the average current transmitted through the switch. In accordance with various example embodiments, the alpha switch 101 and beta switch 102 may be caused to open and close at a speed selected depending on sizes of the inductors (faster speeds can result in smaller inductors) and on the limitations of the switches involved (e.g., the switches may become inefficient when operated close to their switching speed limits.) In one example embodiment, the alpha switch 101 and the beta switch 102 are configured to switch at speed between 10 KHz and 1 MHz, though any suitable switching speed may be used. In various embodiments, the beta switch 102 may be in series with a string of inductors.

In various embodiments, the beta switch 102 may be in series with a string of inductors, and the string of inductors may be connected between the alpha switch 101 and the beta switch 102. In various embodiments, the alpha switch 101 may be connected on one end to the positive terminal 191 of the power source. In various embodiments the alpha switch 101 may be connected in series with the first inductor 115. In various embodiments, the beta switch 102 may be connected to the negative terminal 192 of the power source. In various embodiments, the beta switch 102 may be connected in series with the third inductor 155.

In various embodiments, the number of inductors may be equal to or greater than the number of cells. In various embodiments, the number of internal switches may be equal to one less than the number of cells. In various embodiments, for each additional cell that is added to the balancing circuit, an additional inductor and internal switch may be added. In various embodiments, there may be an alpha switch 101 connected to both the positive terminal 181 of the string of cells and to the positive terminal 191 of the power supply, and there may be a beta switch 102 connected to the negative terminal 182 of the string of cells and to the negative terminal 192 of the power supply.

With reference now to FIG. 1A, in various embodiments, the balancer circuit 100 may include three cells and at least three inductors. The balancer circuit 100 may comprise a first cell 110, a second cell 130, and a third cell 150. In various embodiments, the first cell 110, the second cell 130, and the third cell 150 are arranged in series. For example, the positive terminal of the first cell 110 may be connected to the positive terminal 191 of the power supply, the negative terminal of the first cell 110 may be connected to the positive terminal of the second cell 130, the negative terminal of the second cell 130 may be connected to the positive terminal of the third cell 150, and the negative terminal of the last cell, or third cell 150, is connected to the negative terminal 192 of the power supply.

Moreover, in various embodiments, balancer circuit 100 may further comprise the alpha switch 101, the first internal switch 120, the second internal switch 140, the first inductor 115, the second inductor 135, the third inductor 155, and the beta switch 102. In this example embodiment, the positive terminal of the alpha switch 101 is connected to the positive terminal 191 of the power supply, the negative terminal of the alpha switch 101 is connected to the positive terminal of the first inductor 115, the negative terminal of the first inductor 115 is connected to the positive terminal of the second inductor 135, the negative terminal of the second inductor 135 is connected to the positive terminal of the third inductor 155, the negative terminal of the third inductor 155 is connected to the positive terminal of the beta switch 102, and the negative terminal of the of the beta switch 102 is connected to the negative terminal 192 of the power supply. Moreover, first internal switch 120 may be connected between the negative terminal of first cell 110 and positive terminal of second cell 130 on one end, and between the negative terminal of first inductor 115 and positive terminal of second inductor 135 on the other end. Moreover, second internal switch 140 may be connected between the negative terminal of second cell 130 and positive terminal of third cell 150 on one end, and between the negative terminal of second inductor 135 and positive terminal of third inductor 155 on the other end.

In various embodiments, each of the cells may be upbalanced or downbalanced by adjusting current flow through the internal switches, the alpha switch 101 and the beta switch 102. The current applied to each cell may be adjusted to allow for the state of charge for each of the cells to be roughly equal.

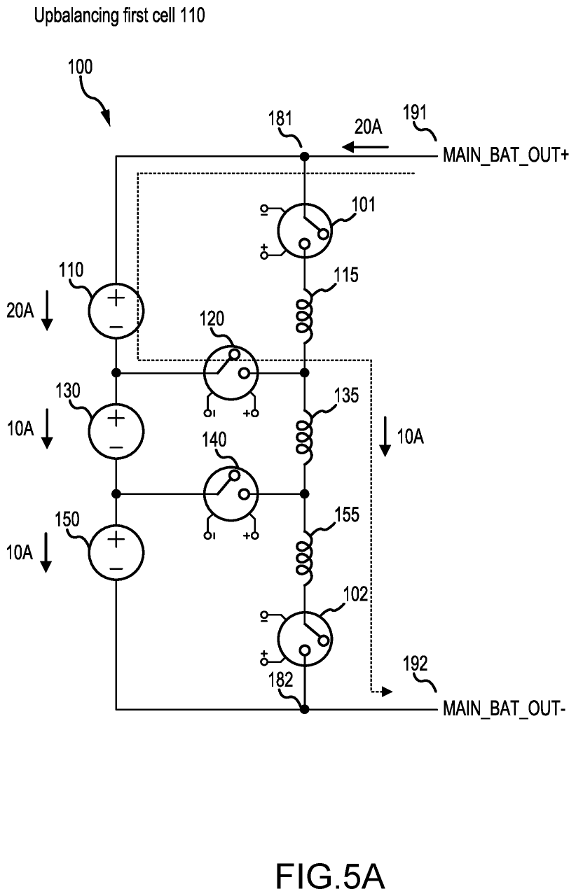

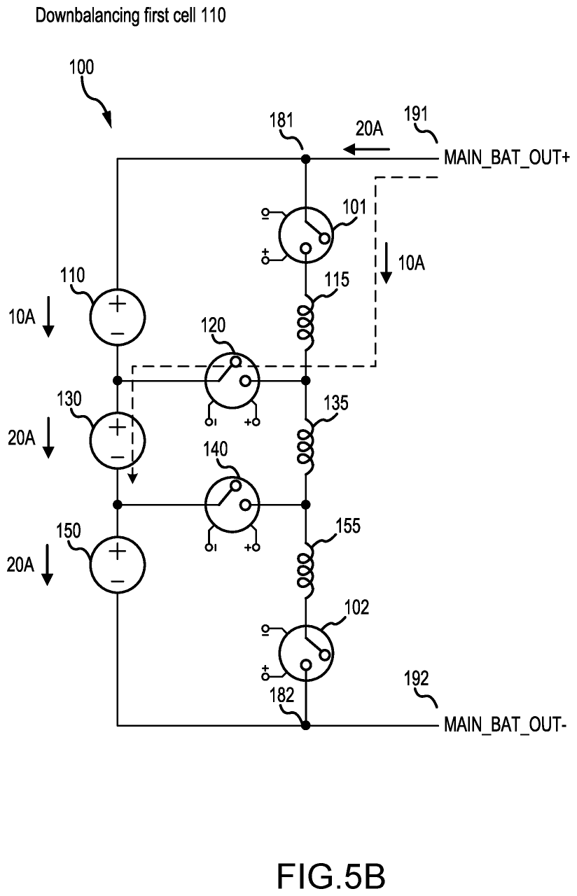

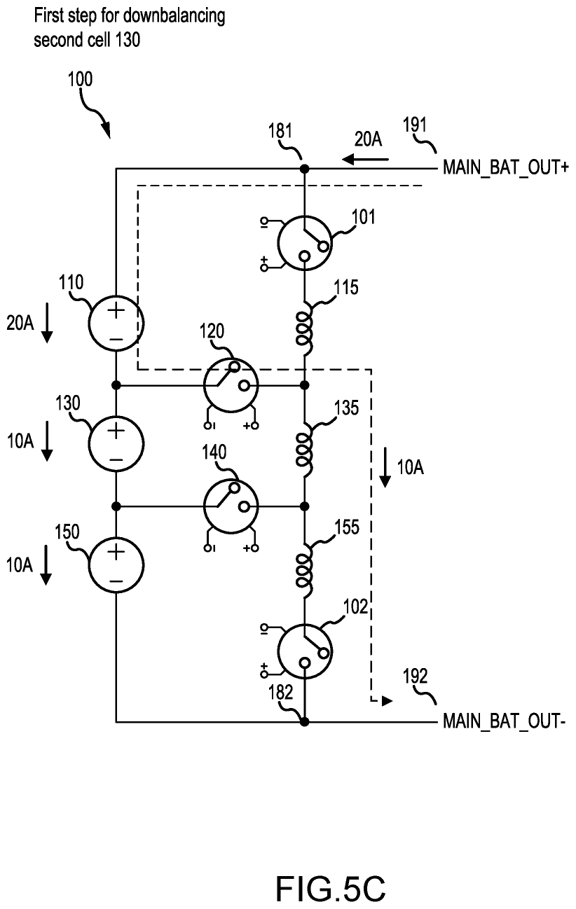

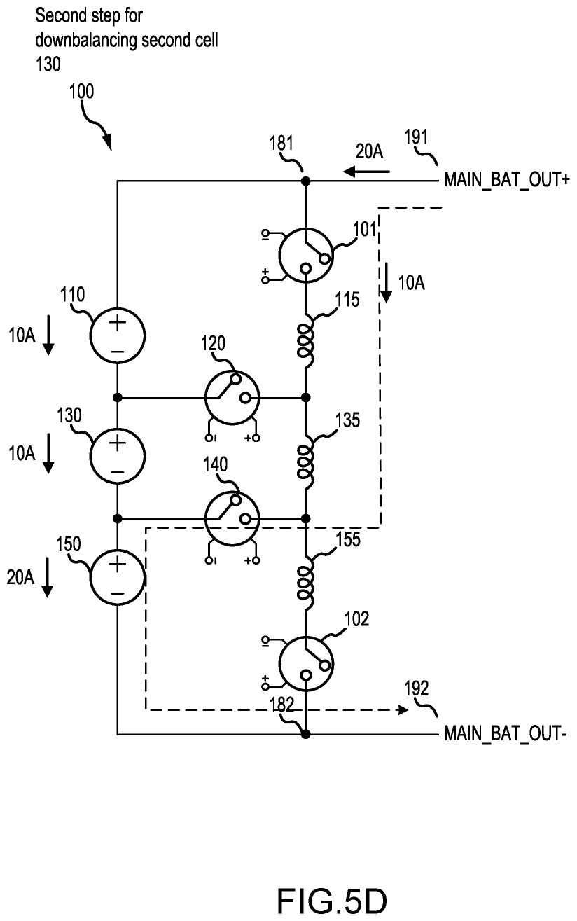

Unbalancing of top battery (first cell 110 undercharged). In an example embodiment, and with momentary reference to FIG. 5A, the first cell 110 may be upbalanced, when the first cell 110 is insufficiently charged. As mentioned above, when the first cell 110 is insufficiently charged the first cell 110 may discharge to a minimum voltage prior to the other cells in the string of cells, and the discharge of all the cells in the string may be halted early. This may limit the total energy available to the battery.

In various embodiments, the balancer circuit 100 may control the switches to provide greater current to the first cell 110 than to the second cell 130 and third cell 150. For example, in various embodiments, the balancer circuit 100 may command the alpha switch 101 to be open, the beta switch 102 to be closed periodically, the first switch 120 to be closed, and the second switch to be open. In various embodiment, this switching configuration may cause the current to be split with a portion of the current that passes through the first cell 110 being directed through the second cell 130 and third cell 150, and another portion directed through the first switch 120 to the second inductor 135, then to the third inductor 155, then through the third inductor 155, and then to the negative terminal 192 (MAIN_BAT_OUT−) of the power supply.

In various embodiments, for example, the switching speed and duty cycle of the beta switch 102 is chosen to allow for 10 amps of current to flow through the second inductor 135 and the third inductor 155. Accordingly, the first cell 110 may receive 20 amps of charge current, and the second cell 130 and the third cell 150 may receive 10 amps of charge current. Accordingly, a greater charge current is applied to the first cell 110, which allows the state of charge of the first cell 110 to increase in relation to the other cells. (i.e. the first cell 110 is upbalanced) with respect to the other two sub-batteries or cell. In an example embodiment, all inductors may be similar in inductance, however this disclosure is not so limited.

It should be noted that this does not come for free. The energy is (in effect) coming from the other two sub-batteries, either by directly transferring their energy, or by reducing the energy available to charge them. However, by using some of the available energy to bring all sub-batteries to the same charge state, the available amount of energy from the battery is maximized.

Downbalancing of top battery (first cell 110 is overcharged). In an example embodiment, and with momentary reference to FIG. 5B, the balancer circuit 100 may be configured to downbalance the first cell 110 when the first cell 110 is overcharged. If the first cell 110 is not downbalanced, then the first cell 110 will reach its maximum voltage during charge before the other cells and charging of the whole string of cells will be halted early, limiting the total energy that can be stored in the battery. In various embodiments, the balancer circuit 100 is configured to command the alpha switch 101 to be periodically closed, the beta switch to be open, the first switch 120 to be closed, and the second switch 140 to be open. In various embodiments, this switch configuration may cause the current from the power supply to be directed through the alpha switch 101, through the first switch 120 to the second cell 130, then to the third cell 150, then to the negative terminal 192 (MAIN_BAT_OUT−) of the power supply. This has the effect of shunting some of the current around the first cell 110 via an alternate path.

In various embodiments, for example, the switching speed and duty cycle of the alpha switch 101 is chosen such that 10 amps of current flows through the first cell 110 and 10 amps of current flows through the alpha switch 101. Accordingly, the third cell 150 and the second cell 130 receive the 20 amps of charge current. Accordingly, the first cell 110 receives a lower charge current in relation to the other cells (i.e. first cell 110 is downbalanced) with respect to the other two sub-batteries or cells.

Internal Cell Overcharged or Undercharged (two-step process). In an example embodiment, an internal cell may be upbalanced where the cell is under charged or downbalanced where the cell is over charged. An internal cell may be a cell that is between two or more cells in a string of cells. In various embodiments, the internal cell may be upbalanced or downbalanced by the steps of upbalancing or downbalancing various sections of the string of cells, wherein there is a net upbalancing or downbalancing of an internal cell in the string.

For example, the second cell 130 may be downbalanced where the second cell is overcharged relative to the third cell 150 and the first cell 110. In various example embodiments, the balancer circuit 100 may downbalance the second cell 130, by downbalancing the second cell 130 and the third cell 150, and then downbalancing the first cell 110 and the second cell 130, so the net balancing results in a downbalance of the second cell 130. In another example embodiment, the order of those two steps may be reversed. By way of further detailed example, and with momentary reference to FIG. 5C, the third cell 150 and the second cell 130 may be downbalanced by causing the respective state of the switches to be: the first switch 120 is closed, the second switch open, the alpha switch 101 is open and the beta switch 102 is closed periodically. Accordingly, a lower charge current is applied to the second cell 130 and third cell 150, in relation to the first cell 110. In various embodiments, and with momentary reference to FIG. 5D, the first cell 110 and the second cell 130 may be downbalanced by causing the respective states of the switches to be: the first switch 120 is open, the second switch 140 is closed, the alpha switch 101 is periodically closed, and the beta switch is open. Accordingly, a lower charge current is applied to the second cell 130 and the first cell 110, in relation to the third cell. Thus, the combined effect of these two steps is to charge the second cell less than the first cell and third cell, thus bringing all the cells in balance or closer to being in balance.

Similar techniques may be used to upbalance an internal cell. For example, to upbalance an internal cell, the balancer circuit 100 may be configured to: (1) downbalance the top cell and downbalance the bottom cell (in any order), effectively upbalancing the internal cell; or (2) upbalance the internal cell and top cell, and upbalance the internal cell and bottom cell (in any order), effectively charging the internal cell more than the top and bottom cells.

In accordance with various embodiments, the string of cells may be downbalanced or upbalanced by directing the internal switches, the alpha switch 101 and the beta switch 102. In various embodiments, the internal cells may be upbalanced or downbalanced by alternating the upbalancing or downbalancing of the cells. In various embodiments, the process of upbalancing or downbalancing may be alternated at a fairly slow rate, on the order of once a second to once a minute, though this disclosure is not limited in this regard.

In various embodiments, the process of upbalancing or downbalancing an internal cell in a string of cells may be used in any length string by first isolating a first sub-string and downbalancing that first sub-string, then isolating a second sub-string that overlaps with the first sub-string by one cell and downbalancing the second sub-string. In various embodiments, a controller may monitor the cells and control the switches to provide upbalancing or downbalancing.

In various embodiments, a second balancer circuit 100 may be connected to the same string of cells. Accordingly, a second balancer circuit 100 can upbalance or downbalance a series of cells as the first balancing circuit also upbalances or downbalances the same string of cells.

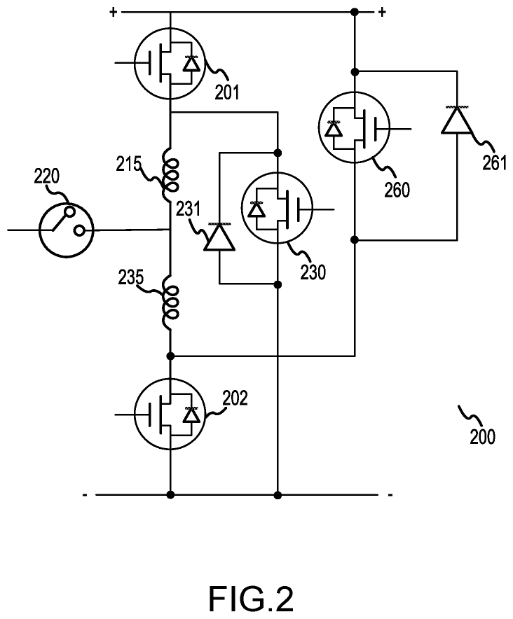

With reference now to FIG. 2, in various embodiments the alpha switch 101 and the beta switch 102 may be “fast” switches. In various embodiments, the alpha switch 101 and the beta switch may be MOSFETs or other device that can switch rapidly, on the order of 10 KHz-1 MHz. In various embodiments, the alpha switch 101 and the beta switch 102 may provide a pathway for the inductive energy during switching.

In various embodiments, a balancer circuit 200 is illustrated. The balancer circuit 200 may be similar to the balancer circuit 100 with additional energy recovery circuits illustrated in addition to the components described with reference to balancer circuit 100. For example, the balancer circuit may comprise an alpha switch 201, similar to the alpha switch 101, a beta switch 202, similar to the beta switch 102, inductors 215/235, similar to inductors 115/135, internal switch 220, similar to first internal switch 120, a first energy recovery switch 230, a diode 231, a second energy recovery switch 260, and a diode 261.

In various embodiments, when alpha switch 201 closes, and internal switch 220 is closed, then current will begin to flow through alpha switch 201, through inductor 215, into the junction between the two cells. When alpha switch 201 is opened, the current begins to taper off. However, since an inductor cannot instantaneously change current, current will continue to flow for some time. If there is no path for it to flow, it could potentially damage alpha switch 201 due to large voltage transients generated by the inductor.

In various embodiments, a first diode 231 may be connected in parallel to first energy recovery switch 230. In various embodiments, the first diode 231 may be configured to provide a current pathway for the inductive energy. In some cases, the diode may be sufficient. Note that if the first energy recover switch 230 is a MOSFET (as shown in FIG. 2) there will be a body diode that will also partially replace the need for first diode 231. However, body diodes in MOSFETs are often poor, so in some cases both first diode 231 and first energy recovery switch 230 may be needed to ensure sufficient design margin and power handling capability.

In various embodiments, the balancer circuit 200 may include a second energy recovery switch 260 and a second diode 261. In various embodiments, the second diode 261 may be connected in parallel to the second energy recovery switch 260. In various embodiments, beta switch 202, second energy recovery switch 260 and second diode 261 may be configured to connect to the components alpha switch 201, first energy recovery switch 230 and first diode 231 so that they mirror each other. In accordance with this embodiment, beta switch 202, second energy recovery switch 260 and second diode 261 may be used to withdraw current from a junction between two cells.

In an example embodiment, this additional circuitry illustrated in FIG. 2 is configured to prevent damage to alpha switch 201 (and similarly to the beta switch 202). When the alpha switch shuts off the voltage will go negative and rapidly get very negative, and that can damage alpha switch 201. The diode/switch 231/230 provide a path for current to flow from the negative terminal and prevent the voltage at that node from going too negative. Second, this additional circuitry is configured to provide a path to return that inductive energy to the battery, thus making the balancer considerably more efficient. Moreover, any other suitable circuitry may be added.

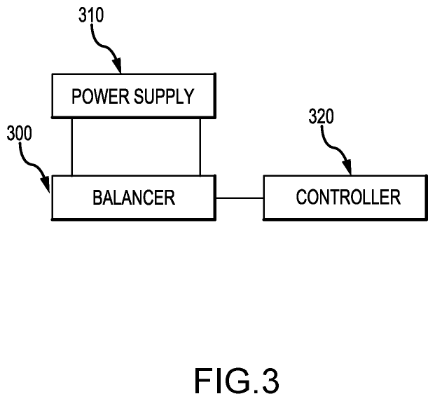

With reference to FIG. 3, in various embodiments, the balancer circuit 300 may be connected to a power supply 310 and a controller 320. The power supply 310 may be any suitable system for supplying power to charge the battery. In an example embodiment, the controller 320 may be connected with one or more of the switches. In various embodiments, the controller may be configured to open or close the one or more switches to adjust balancing of the cells, in accordance with the various example embodiments and techniques described herein. In various embodiments, a controller may be used to control the internal switches, the alpha switch 101 and the beta switch 102. In various embodiments, multiple controllers may be used to control each of the switches. In various embodiments, the controller may manage the measurement of charge state and the opening and closing of each of the switches.

In various embodiments, the controller may receive input reflecting the balance state of the two or more cells. Stated another way, the controller may receive input reflecting the state of charge of two or more of the cells. This input may be received, for example, from a battery management system. In various embodiments, the controller may be configured to track the charge state of each cell. For example, in various embodiments, the controller may measure the current accumulation at each battery or cell. In various embodiments, the controller may estimate the charge state of each cell by measuring the voltage and measured impedance, or by other means.

In various embodiments, the controller may be configured to control the internal switches. In various embodiments, the controller may manage the internal switches to ensure that only one internal switch is closed at a time. Further, in various embodiments, the controller may ensure that the internal switches are switched (i.e. opened/closed) when minimal current is flowing through the system.

In various embodiments, the controller may manage the alpha switch 101 and beta switch 102. For example, in various embodiments, the controller may use a Pulse Width Modulation (PWM) generator to manage the alpha switch 101 and beta switch 102. In various embodiments, a PWM generator may be used to manage the alpha switch 101 and beta switch 102 to allow for significant flexibility in output waveform. For example, a PWM generator may be used to control the alpha switch 101 and beta switch 102 in a similar manner to that of a synchronous buck converter controller.

In various embodiments, the controller may be configured to ensure the safe and effective operation of the switches, by coordinating the switching of the internal switches, the alpha switch 101 and the beta switch 102. In various embodiments, the alpha switch 101 and beta switch 102 may be open completely for a period of time before the internal switches are switched, to ensure that no current is passed through the internal switches as they are switched.

In various example embodiments, the controller may ensure that the internal switches are never all closed at the same time. Where the internal switches are closed at the same time this may cause an overcurrent and trip the protective devices within the circuit.

In various embodiments, the balancer circuit 100 may further comprise overcurrent devices. In various embodiments, over current devices may be configured between one or more of the switches and cells. In various embodiments, overcurrent devices may interrupt the power flow wherein an over current is detected. In various embodiments, a controller may be configured to detect over current.

In various embodiments, the balancer circuit 100 may work in concert with devices needed to monitor the sub-batteries. Ordinarily battery management systems (“BMS”) monitor voltages of each cell to prevent damaging undervoltages or overvoltages. By combining this balancer with the wiring used by the BMS to monitor each cell, labor and materials are reduced overall.

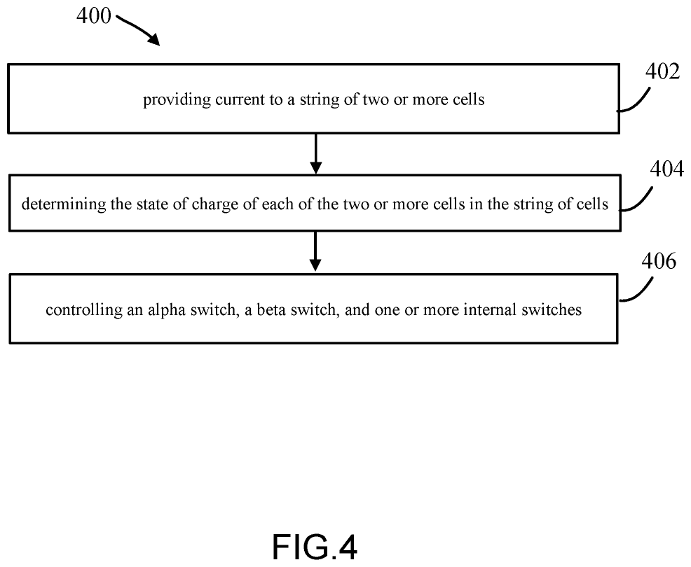

FIG. 4 is a flow diagram illustrating an example method 400 for balancing a string of battery cells. This example method may include providing current to a string of two or more cells (402). For example, a power source may provide a current to one or more cells in a string of cells.

In accordance with various example embodiments, the method may further comprise determining the state of charge of each of the two or more cells in the string of cells (404). For example, a controller may be configured to determine the state of charge of two or more of the cells.

In accordance with various example embodiments, the method may further comprise controlling (406) an alpha switch, a beta switch, and one or more internal switches to balance the two or more cells. For example, a controller may control an alpha switch, a beta switch, and one or more internal switches. In an example embodiment, the controller may control the alpha switch, the beta switch, and one or more internal switches based on the measuring of the state of charge of each of the two or more cells in the string of cells. In this example, the number of internal switches may be one less than the number of cells in the string of cells. Further in this example embodiment, each of the one or more internal switches may be connected on a first end between two cells of the string of cells and on a second end between the alpha switch and the beta switch.

In an example embodiment, the controlling step (406) may further comprise: upbalancing a first cell relative to a second cell, down balancing a first cell relative to a second cell, upbalancing/downbalancing a bottom cell relative to one or more other cells, upbalancing/downbalancing an internal cell relative to one or more other cells.

There are many benefits to the various embodiments described herein over prior battery balancing systems, devices and methods. In a first example, the balancer circuit 100 is configured such that the series-inductor arrangement ensures that a similar PWM drive (similar frequency/similar duty cycle) will result in a similar current flow. Changing taps to a midpoint that is double the voltage will automatically double the inductance. Since per the inductor equation, ΔI=(V/L)ΔT, as long as the (V/L) term is kept constant, the current will be as well for a given timing. In addition, distributed inductance is easier to build than one large inductor.

In a second example embodiment, the balancer circuit 100 is configured to not require isolation or transformers, thus reducing cost. In a third example embodiment, the balancer circuit 100 is configured to only requires two fast switches no matter how large the series battery string or cells becomes. The internal switches can be slow/low-cost switches (such as, e.g. back-to-back SiCFETs or even relays, though this disclosure is not limited in this regard), and the relatively more expensive alpha and beta switches do not increase cost as the number of cells increases. In fourth example embodiment, the balancer circuit 100 may comprise parallel balancers (more than one balancer used per string) for increased balancing power. These additional balancers may be configured to balance various cells in parallel to more quickly bring the cells in balance. In another example embodiment, the balancer circuit 100 is configured to balance cells at any stage of charging or discharging, as opposed to systems (like resistive voltage-based charging) that can only be used at the end of a charge cycle.

Example embodiments of the systems, methods, and devices described herein may be implemented in hardware, software, firmware, or some combination of hardware, software, and firmware. For example, the block diagrams of FIG. 4 may be implemented in hardware, software, firmware, or some combination of hardware, software, and firmware.

In the present disclosure, the following terminology will be used: The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” means quantities, dimensions, sizes, formulations, parameters, shapes, and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including, for example, tolerances, measurement error, measurement accuracy limitations and other factors known to those of skill in the art, may occur in amounts that do not preclude the effect the characteristic was intended to provide. Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in the numerical range are individual values such as 2, 3 and 4 and sub-ranges such as 1-3, 2-4 and 3-5, etc. The same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

It should be appreciated that the particular implementations shown and described herein are illustrative of the example embodiments and their best mode and are not intended to otherwise limit the scope of the present disclosure in any way. Furthermore, the connecting lines shown in the various figures contained herein are intended to represent example functional relationships and/or physical couplings between the various elements. It should be noted that many alternative or additional functional relationships or physical connections may be present in a practical device.

As one skilled in the art will appreciate, the mechanism of the present disclosure may be suitably configured in any of several ways. It should be understood that the mechanism described herein with reference to the figures is but one example embodiment of the disclosure and is not intended to limit the scope of the disclosure as described above.

It should be understood, however, that the detailed description and specific examples, while indicating example embodiments of the present disclosure, are given for purposes of illustration only and not of limitation. Many changes and modifications within the scope of the instant disclosure may be made without departing from the spirit thereof, and the disclosure includes all such modifications. The corresponding structures, materials, acts, and equivalents of all elements in the claims below are intended to include any structure, material, or acts for performing the functions in combination with other claimed elements as specifically claimed. The scope of the disclosure should be determined by the appended claims and their legal equivalents, rather than by the examples given above. For example, the operations recited in any method claims may be executed in any order and are not limited to the order presented in the claims. Moreover, no element is essential to the practice of the disclosure unless specifically described herein as “critical” or “essential.”

### STATEMENTS OF INVENTION

Statement 1. A method for balancing a string of battery cells comprising: providing, by a power source, current to a string of two or more cells; determining, by a controller, a state of charge of each of the two or more cells in the string of cells; and controlling the balance of the cells, by the controller, an alpha switch, a beta switch, and one or more internal switches based on the measuring of the state of charge of each of the two or more cells in the string of cells; wherein the number of internal switches is one less than the number of cells in the string of cells; and wherein each of the one or more internal switches is connected on a first end between two cells of the string of cells and on a second end between the alpha switch and the beta switch.

Statement 2. The method for balancing a string of battery cells according to Statement 1, wherein the controlling further comprises: upbalancing a first cell in the string of cells, wherein the first cell has a state of charge that is less than the state of charge of each of the other cells.

Statement 3. The method for balancing a string of battery cells according to Statement 2, wherein the upbalancing further comprises: providing a greater current to the first cell by causing the respective states of the switches to be: the alpha switch is open; the beta switch is closed periodically; a first internal switch is closed; and the other internal switches are open.

Statement 4. The method for balancing a string of battery cells according to Statement 1, wherein the controlling further comprises: downbalancing a first cell in the string of cells, wherein the first cell has a state of charge that is greater than the state of charge of each of the other cells.

Statement 5. The method for balancing a string of battery cells according to Statement 4, wherein the downbalancing further comprises: providing a lower current to the first cell by causing the respective states of the switches to be: the alpha switch is closed periodically; the beta switch is open; a first internal switch is closed; and the other internal switches are open.

Statement 6. The method for balancing a string of battery cells according to Statement 2, wherein the string of cells includes three or more cells, and the controlling further comprises: downbalancing a second cell in the string of cells comprising: upbalancing the first cell in the string of cells by causing the respective states of the switches to be: the alpha switch is open; the beta switch is closed periodically; a first internal switch is closed; and the remaining internal switches are open; and upbalancing a third cell in the string of cells by causing the respective states of the switches to be: the alpha switch is closed periodically; the beta switch is open; a second internal switch is closed; and the remaining internal switches are open.

Statement 7. The method for balancing a string of battery cells according to Statement 2, wherein the providing a current to a string of cells comprises providing a current to three or more cells, a negative terminal of the first cell and a positive terminal of a second cell is connected to a first switch, the first switch is in electrical connection with the alpha switch by a first inductor; and a negative terminal of the second cell and the positive terminal of a third cell is connected to a second switch, the second switch in electrical connection with the beta switch by a second inductor.

What is claimed:

1. A serial tapped inductor battery balancing device comprising:
a positive terminal of a power source connected to a first cell and an alpha switch;
a second cell and a first switch both in electrical connection with a negative terminal of the first cell; and
a third cell and a second switch both in electrical connection with a negative terminal of the second cell;
the alpha switch in series with a first inductor;
the first inductor both in electrical connection with the first switch and a second inductor;
the second inductor both in electrical connection with the second switch and a third inductor;
the third inductor in series with a beta switch; and
the beta switch and the third cell both in electrical connection with a negative terminal of the power source.

2. The serial tapped inductor battery balancing device of claim 1, further comprising:
a controller in electrical connection with one or more of the switches, the controller configured to open or close the one or more switches to adjust the current provided to one or more of the cells.

3. The serial tapped inductor battery balancing device of claim 2, wherein the controller further comprises a battery monitoring system configured to track a state of charge of two or more of the cells.

4. The serial tapped inductor battery balancing device of claim 3, wherein the alpha switch and the beta switch are fast switches.

5. The serial tapped inductor battery balancing device of claim 3, wherein a junction between the alpha switch and the first inductor is connected to a cathode of a first diode, and an anode of the first diode is connected to the negative terminal of the power source.

6. The serial tapped inductor battery balancing device of claim 3, wherein a junction between the beta switch and the third inductor is connected to an anode of a second diode, and a cathode of the second diode is connected to the positive terminal of the power source.

7. The serial tapped inductor battery balancing device of claim 4, wherein the controller is configured to upbalance the first cell when the first cell state of charge is less than the state of charge of the other cells, by providing a greater current to the first cell than the other cells by causing the respective states of the switches to be:
the alpha switch is open;
the beta switch is closed periodically;
the first switch is closed; and
the second switch is open.

8. The serial tapped inductor battery balancing device of claim 4, wherein the controller is configured to downbalance the first cell when the first cell state of charge is greater than the state of charge of the other cells, by providing a lesser current to the first cell than the other cells by causing the respective states of the switches to be:
the alpha switch is closed periodically;
the beta switch is open;
the first switch is closed; and
the second switch is open.

9. The serial tapped inductor battery balancing device of claim 4, wherein the controller is configured to upbalance a cell that has a low state of charge, and downbalance a cell that has a high state of charge.

10. A system for serial tapped inductor battery balancing comprising:
a chain of cells and a chain of inductors;
a power source connected to the chain of inductors and the chain of cells;
wherein the chain of inductors is connected to a positive terminal of the power source by an alpha switch, and to a negative terminal of the power source by a beta switch; and
a first switch connected between the chain of cells and the chain of inductors;
wherein the first switch is connected to the chain of cells between a first cell and a second cell; and
wherein the first switch is connected to the chain of inductors between a first inductor and a second inductor.

11. The system for serial tapped inductor battery of claim 10, further comprising:
a second switch connected between the chain of cells and the chain of inductors;
wherein the second switch is connected to the chain of cells between the second cell and a third cell; and
wherein the second switch is connected to the chain of inductors between the second inductor and a third inductor.

12. The system for serial tapped inductor battery of claim 10, further comprising:
a controller in electrical connection with one or more of the switches, the controller configured to open or close the one or more switches to adjust the current provided to one or more of the cells.

13. The system for serial tapped inductor battery of claim 12, wherein the controller further operates in combination with a battery monitoring system configured to track a state of charge of two or more of the cells.

14. The system for serial tapped inductor battery of claim 13, wherein the controller is configured to upbalance the first cell when the first cell state of charge is less than the state of charge of the other cells, by providing a greater current to the first cell than to the other cells by causing the respective states of the switches to be:
the alpha switch is open;
the beta switch is closed periodically;
the first switch is closed; and
a second switch is open.

15. The system for serial tapped inductor battery of claim 13, wherein the controller is configured to downbalance the first cell when the first cell state of charge is greater than the state of charge of the other cells, by providing a lesser current to the first cell than to the other cells by causing the respective states of the switches to be:
the alpha switch is closed periodically;
the beta switch is open;
the first switch is closed; and
a second switch is open.

16. A serial tapped inductor battery balancer comprising:
a string of cells in series;
a power source connected by a positive terminal of the power source to a first end of the string of cells and by a negative terminal to a second end of the string of cells;
an alpha switch in series with a beta switch;
wherein the alpha switch is connected to the positive terminal of the power source; and
wherein the beta switch is connected to the negative terminal of the power source;
a first switch connected on a first end between a first cell and a second cell in the string of cells, the first switch connected on a second end between the alpha switch and the beta switch; and
a controller configured to control the first switch, the alpha switch and the beta switch to upbalance or downbalance one or more of the cells in the string of cells.

17. The serial tapped inductor battery balancer of claim 16, wherein the controller further operates in combination with a battery monitoring system configured to track a state of charge of two or more of the cells.

18. The serial tapped inductor battery balancer of claim 17, wherein the alpha switch and the beta switch are fast switches.

19. The serial tapped inductor battery balancer of claim 18, further comprising a string of inductors, wherein the string of inductors are connected on a first end to the alpha switch and on a second end to the beta switch.

20. The serial tapped inductor battery balancer of claim 19, wherein the number of inductors in the string of inductors is equal to or greater than the number of cells in the string of cells.

21. The serial tapped inductor battery balancer of claim 20, wherein the first switch is connected on the second end to the alpha switch by a first inductor and to the beta switch by a second inductor.
